(19) United States
(12) Patent Application Publication
(10) Pub. No.: US 2005/0047849 A1
(43) Pub. Date: Mar. 3, 2005

(54) Linear adjustment element

(76) Inventor: Horst Ollefs, Moers (DE)

Correspondence Address: HARNESS, DICKEY & PIERCE, P.L.C., P.O. BOX 828, BLOOMFIELD HILLS, MI, 48303, US

(21) Appl. No.: 10/927,274

(22) Filed: Aug. 26, 2004

(30) Foreign Application Priority Data
Aug. 27, 2003 (DE) 10339819.8

(51) Int. Cl. F16B 7/10

(52) U.S. Cl. 403/31

(57) ABSTRACT

A linear adjustment element, which can be extended along a longitudinal axis between a shortened retracted position and a moved out position, has a first connection element 1, a second connection element 8, and a hose-like expansion element 22. The hose-like extension element 22 can be elastically elongated and is air-tight and liquid-tight. The hose-like expansion element 22 is connected in a sealed manner at its first end portion 23 to the first connection element 1 and at its second end portion 24 to the second connection element 8. The hose-like expansion element 22 has an outer face 25. A pressure chamber 29, delimited by the connection elements 1, 8and the expansion element 22, can be pressurised and depressurised via a tube element 6. A support element 26 is arranged around the outer face 25 of the expansion element 22.

### CROSS-REFERENCE TO RELATED APPLICATIONS

This application claims priority to German Patent Application Nos. 10339819.8 filed Aug. 27, 2003, which application is herein expressly incorporated by reference.

### FIELD OF THE INVENTION

The invention relates to a linear adjustment element, which is adjustable along a longitudinal axis between a shortened retracted position and an extended moved out position.

### BACKGROUND OF THE INVENTION

DE 39 09 370 A1 describes a single acting pressure loadable telescopic cylinder. The cylinders individual telescopic portions move out under a pressure loading to the extended position. A mechanical return retraction is provided. The mechanical return includes a rope winch, driven by a motor with a free-wheel coupling provided between the two. The free end of the rope, wound onto the rope winch, is connected to the inner telescopic portion that moves out the furthest. During pressure loading, all telescopic portions move out, wherein the rope is wound off the winch until the longest extension position is reached. If the telescopic cylinder should be pulled in, e.g., returned to its retracted or shortened position, a pressure release and additionally a return of the telescopic portions by the: rope winch driven by the mating motor is carried out so that the rope is shortened. Thus, the individual portions move until they are received within each other.

Such a telescopic cylinder can only be used for devices provided with a corresponding space, however, it can not be used in tight space conditions. Another disadvantage is that the guiding faces are exposed to the exterior Accordingly, environmental influences can negatively influence the function.

WO 85/00203 A1 relates to a valve system with a hydraulic power drive to open the valve. This power drive has a linear adjustment element, which is adjustable along a longitudinal axis between a shortened retracted position and an extended moved out position. It includes a first connection element in the form of a rod with an end plate and a second connection element formed also as a rod and provided with an end plate. A corrugated bellows is provided between the two end plates. The corrugated bellows together with the two end plates encloses a pressure chamber. The pressure chamber includes a connection tube, for pressure loading and pressure release, which extends through the second connection element. Furthermore a support element in the form of a tube is provided. The support element is rigidly connected to the first connection element and is displaceably guided on the second rod-like connection element. The pressure loading of the corrugated bellows is turned into an axial elongation. Corrugated bellows only experience an extension by unfolding of the individual corrugations, which provide the necessary material for the extension. This is especially obvious, when, as proposed, the corrugated bellows should be made from a metal material. Since the corrugated bellows itself can not produce any axial forces and therefore, can not effect a return into the retracted position, the pressure, acting on the valve body, is used, to push the corrugated bellows back into the retracted position. A disadvantage of this adjustment device is that the corrugated bellows, which provides the extension, need to be designed with large radial dimensions to provide the necessary length of the corrugations or need to have a large number of corrugations. If a correspondingly smaller diameter is used, a correspondingly larger number of corrugations is necessary, which leads to a corresponding enlargement of the installation length.

DE 10053846 A1 describes a piston cylinder unit. A retaining element is arranged centrally in the hollow piston rod. The retaining element limits the extension length by the piston abutting a projection on the rod-like retaining element. The rod-like retaining element is provided with a thread. The thread is screwed into a bore in the head cover of the cylinder housing. The thread projects through the head cover of the cylinder to the exterior and can be rotationally loaded, to adjust the extended length. The projection provided at the end of the rod-like retaining element only contacts the piston and does not have any other function besides the function of limiting the extended length.

DE 8003846 U1 discloses a hydraulic or pneumatic actuated single-acting piston cylinder unit. This unit is coaxially enclosed by a tensioning spring connected to the connection end of the cylinder and to the connection end of the piston rod. The hydraulic or pneumatic return, missing in a single-acting piston cylinder unit, is replaced by a tensioning force of the spring.

### SUMMARY OF THE INVENTION

The invention is based on the object, to provide a linear adjustment element, which is small and enables, even though it has small dimensions in the retracted position, a relative large extended length. Further adjustment is not negatively influenced by disadvantageous environmental conditions and/or installation conditions.

According to the invention, a linear adjustment element, adjustable in length along a longitudinal axis between a shortened retracted position and a moved out extended position, comprises a first connection element a second connection element, and a hose-like expansion element. The hose-like expansion element can be extended by an elastic expansion and is air-tight and liquid-tight. The hose-like expansion element is connected by a first end portion to the first connection element and by a second end portion to the second connection element in a tight manner. The hose-like expansion element also has an outer face. A pressure chamber is enclosed by the connection elements and the expansion element. The pressure chamber is connected to a connection line for pressurizing and for pressure release. A support element encloses the outer face of the expansion element. A retaining element limits the extension to the moved out position.

An advantage of this embodiment is, that a hermetically sealed (tight) linear adjustment element is achieved. Thus, disadvantageous environmental conditions, for example when used in agricultural implements or tractors in the fields, do not influence the function of the adjustment element. It is hermetically sealed to the exterior so that when it is used in the fields, the function itself is not negatively influenced when dirt or freezing moisture settles on it. A further advantage is that no sliding guides, as they are commonly provided in adjustment cylinders, are provided. Thus, an operaton essentially free of wear is also possible in a space in which dirt settles.

It is further advantageous that the expansion element is supported in the radial direction. Thus, during pressure loading, only the possibility of an axial expansion along the longitudinal axis is given. The return force is produced by the elastic return of the expansion element itself, via its wall. Thus, the linear adjustment element can take up its retracted position only by the return effect of the elasticity of the expansion element. Pressurised air or also a pressurised liquid can be used as a pressure medium.

In an embodiment of the invention, the connection line is represented by a passage bore of the first connection element or by a tube element received in the same. It is advantageous to use a tube element, when, for example, the respective connection element, in which the tube element is received, is made from a plastic material or a material corresponding to that of the expansion element, having, however, a higher hardness.

Preferably, a retaining element is arranged to limit the expansion into the moved out position. On the one hand, the retaining element is connected to the first connection element and on the other hand it is connected to the second connection element. If this retaining element should have no further function, a tensioning element in the form of a rope, wire or the same is sufficient. If, however, the retaining element should have an additional supporting function for the expansion element against buckling, it is advantageous, to form the retaining element so that it can be telescopically extended and shortened, respectively. Accordingly, the retaining element has telescopic tubes guided within each other and a telescopic rod. The movement is limited along the longitudinal axis in relation to each other. A further advantage in this embodiment is that with a small installation length, a large stroke can be achieved.

Preferably the support element is formed as a helical line wound spiral which is arranged around the outer face of the expansion element. The spiral has no spring effect and thus exerts no tensioning force. A first spiral end and a second spiral end serve for the connection to the first connection element or the second connection element, respectively. The spiral can also be formed as a helical spring. During pressurising of the pressure chamber, the helical spring together with the expansion element experience, along the longitudinal axis, an expansion in the direction to the moved out position and is thus pre-tensioned. This bias can support, during the pressure release of the pressure chamber, the return of the expansion element or of the linear adjustment element to the retracted (shortened) position. A tube can also be provided as a support element. Especially a telescopic tube can be provided, which encloses the expansion element and is guided compared to the same in a friction poor manner, i.e. its upper face has in relation to the expansion element only a small friction.

A compact design is achieved when, for example, the first telescopic tube rests on the first connection element and only then the expansion element is attached with its first end portion. The attachment on the first connection element is achieved by interposition of the telescopic tube.

The tube element, arranged thereto, can be used for the attachment of the first spiral end on the first connection element. Thus, the angled end of the winding of the helical spiral is laid around the tube element.

Preferably, the expansion element is made from a rubber material, which is soft and elastic.

The connection elements can be essentially made from the same material as the expansion element, but need to have a higher hardness. It is, however, also possible, to produce the connection elements from a metal material or a plastic material.

If the telescopic tube, on which the first end portion of the expansion element is mounted or, however, when directly mounting the first end portion of the expansion element on the first connection element made from metal, the connection can be produced for example by gluing or by vulcanizing.

If the expansion element and the connection elements are made from the same material, it is possible, to form, for example, at least one of the end portions of the expansion elements integrally with the respective connection element.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side elevation view of the linear adjustment element in the retracted position;

FIG. 2 is a longitudinal sectional view of the linear adjustment element; and

FIG. 3 is a top plan view to FIG. 1.

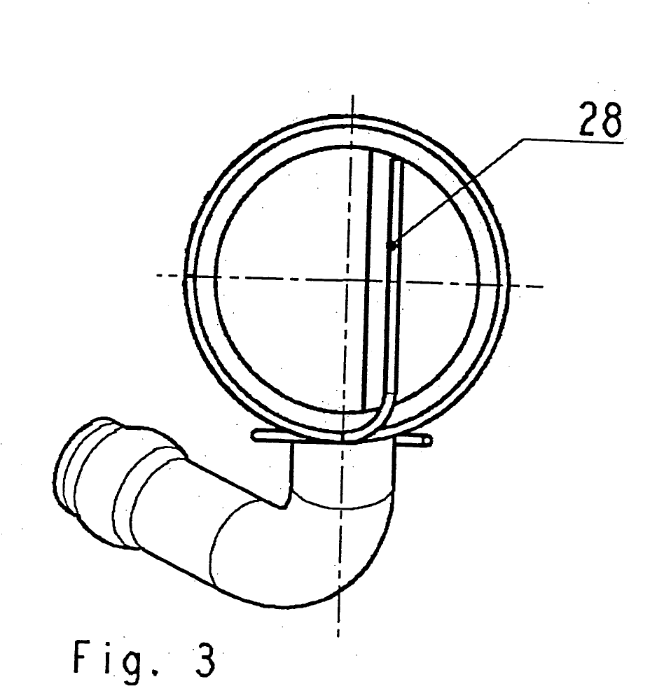

### DETAILED DESCRIPTION OF THE PREFERRED EMBODIMENTS

The following description of the preferred embodiment(s) is merely exemplary in nature and is in no way intended to limit the invention, its application, or uses.

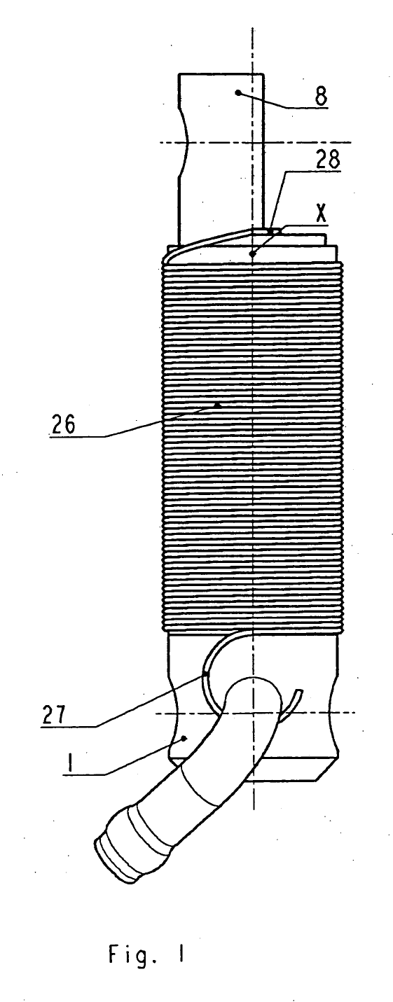

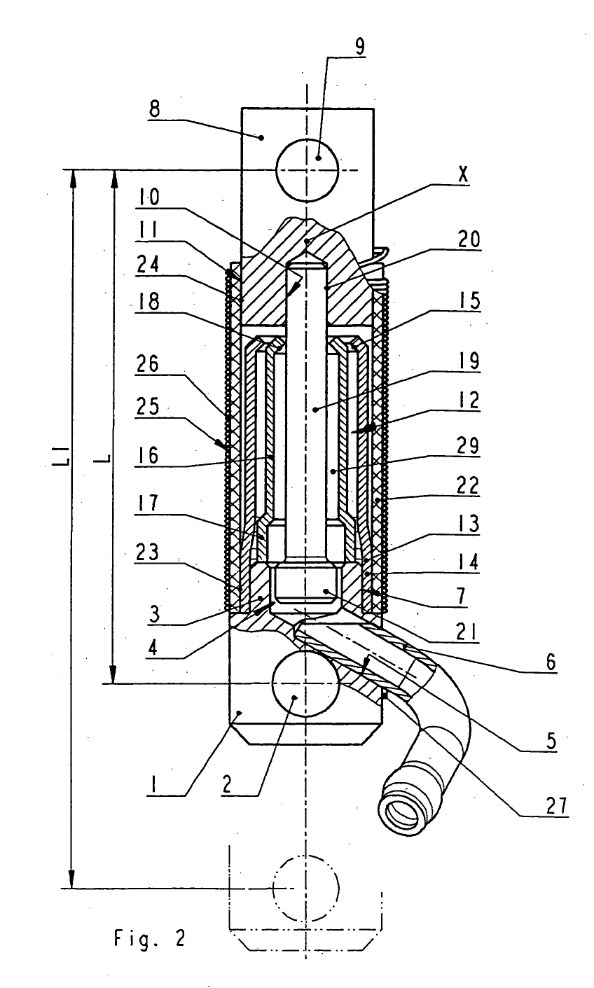

In FIG. 1 the linear adjustment element is shown in the retracted (shortened) position. In FIG. 2 the linear adjustment element is shown in continuous lines in the retracted position with the length L between the connection bores. Furthermore, FIG. 2 shows schematically, by dash-dot lines a lengthened position, extended to the length L1 during pressure loading (pressurisation). The linear adjustment element comprises a first connection element 1, provided with an attachment bore 2 extending transversally to the longitudinal axis X. The attachment bore 2 fixes the first connection element 1 on a component, on which it is supported. The first connection element 1 has a lug 3, provided with a center bore 4, arranged centered on the longitudinal axis X. An inclined bore 5 extends from the exterior and ends in the center bore 4. A connection line 6 is received in the inclined bore 5, which is open towards the external surroundings and towards the centre bore 4. The outer face of the lug 3 forms a circular cylindrical seat face 7.

The linear adjustment element further comprises a second connection element 8, having an attachment bore 9, which extends transversally to the longitudinal axis X. A bore 10 is provided starting from the end face of the second connection element 8 distanced to the attachment bore 9. The portion of the second connection element 8, forming the outer face towards the bore 10, is formed as a circular cylindrical seat face 11.

A retaining element 12 is active between the first connection element 1 and the second connection element 8. The retainer element includes a first telescopic tube 13 resting in a retained and sealed manner on the circular cylindrical seat face 7 of the first connection element 1. The first telescopic tube 13 has a seat portion 14 with an expanded diameter. The end of the first telescopic tube 13 distanced from the seat portion 14 is provided with a collar 15. The collar 15 extends inwards and projects in the direction towards the longitudinal axis X.

A second telescopic tube 16 is received in the first telescopic tube 13. The second telescopic tube 16 has limited movability in relation to the first telescopic tube 13 along the longitudinal axis. It has a tube end 17 with an enlarged diameter. The tube end 17 can be supported, in the retracted position of the linear adjustment element, on the end face of the lug 3 of the first connection element 1. This tube end 17 is enlarged such that, when extending the same, the tube end 17 abuts the collar 15 of the first telescopic tube 13.

A telescopic rod 19 is arranged to the second connection element 8. The telescopic rod 19 rests with a portion 20 in the bore 10 of the second connection element 8. The rod 19 is press-fit into the bore 10 and glued in or is retained in it by a thread. In this case, the bore 10 is formed as a threaded bore. A collar 21 is distanced from portion 20 on the telescopic rod 19. The collar 21 has an enlarged diameter which abuts, when extended, the collar 18 of the second telescopic tube 16 which is directed inwardly towards the longitudinal axis X. Accordingly, as a whole, in the fully moved out (extended) position, the expansion length L1, starting from the retracted length L, is limited mechanically by the retaining element 12 and additionally the expansion element 22 is supported against buckling.

A hose-like expansion element 22 is provided with a smooth inner and outer face. The hose-like expansion element is made from a material which allows an elastic expansion and shortening of the same. Furthermore, the material is air-tight and liquid-tight. This hose-like expansion element 22 rests in a tight manner with its first end portion 23 on the seat portion 14 of the first telescopic tube 13, which rests in a sealed manner with this seat portion 14 on the seat face 7 of the first connection element 1. The connection can, for example, then, when a rubber-like material is used for the expansion element 22, be carried out by vulcanising it onto the first telescopic tube 13. However, a gluing connection or a mounting by means of a support ring, radially loading the expansion element 22, is possible. The second end portion 24 of the expansion element 22 rests on the seat face 11 of the second connection element 8. It is also connected thereto in a sealed and secured manner.

A pressure chamber 29 is formed between the inner face of the hose-like expansion element 22 and the first connection element 1 as well as the second connection element 8. The outer face 25 of the expansion element 22 is enclosed by a support element in the form of a helical spring 26. The helical spring has a small gradient so that many windings are provided. The first spring end 27 of this helical spring 26 is mounted on the connection line 6 of the first connection element 1. The second spring end 28 of the helical spring 26 is retained on a shoulder of the second connection element 8.

If, via the bore of the connection line 6, a pressure agent is transmitted into the pressure chamber 29, for example in the form of compressed air or pressurised liquid, the expansion element 22 is elongated. This occurs due to the elastic expansion of its wall in the direction along the longitudinal axis X. A radial expansion is prevented due to the radial support by the helical spring 26 or by the support element, respectively.

In the embodiment, an elastic biasing is achieved by the expansion element 22 as well as of the helical spring 26 in the direction of the longitudinal axis X. If a pressure release occurs in the pressure chamber 29, the linear adjustment element is elastically returned from the moved out (extended) length L1 to the retracted position, with the installation length L. Accordingly, the spiral spring 26 can facilitate the return movement.

The description of the invention is merely exemplary in nature and, thus, variations that do not depart from the gist of the invention are intended to be within the scope of the invention. Such variations are not to be regarded as a departure from the spirit and scope of the invention.

1. A linear adjustment element adjustable in length along a longitudinal axis between a shortened retracted position and a moved out extended position, comprising:
a first connection element;
a second connection element;
a hose-like expansion element, said hose-like expansion element can be extended by an elastic expansion, and said hose-like expansion element is air-tight and liquid-tight, said hose-like expansion element is connected with a first end portion to the first connection element and with a second end portion to the second connection element in a tight manner, and said hose-like expansion element has an outer face;
a pressure chamber enclosed by the connection elements and the expansion element, said pressure chamber connected by a connection line for providing a pressurizing loading and a pressure release;
a support element, said support element enclosing the outer face of the expansion element; and
a retaining element for limiting the extension to the moved out position.

2. The linear adjustment element according to claim 1, wherein the connection line is represented by a passage bore of the first connection element or by a tube element received in the same.

3. The linear adjustment element according to claim 1, wherein the retaining element is connected to the first connection element and connected to the second connection element.

4. The linear adjustment element according to claim 1, wherein the retaining element is arranged in the pressure chamber.

5. The linear adjustment element according to claim 1., wherein the retaining element is telescopically extendable and retractable.

6. The linear adjustment element according to claim 5, wherein the retaining element comprises telescopic tubes guided within each other and a telescopic rod, which movement is limited to each other along the longitudinal axis.

7. The linear adjustment element according to claim 1, wherein the retaining element supports the expansion element against lateral buckling.

8. The linear adjustment element according to claim 1, wherein the support element is formed as a helical line-like wound spiral, arranged around the outer face of the expansion element, said helical line-like wound spiral having a first spiral end and a second spiral end, said first spiral end is connected to the first connection element and the second spiral end is connected to the second connection element.

9. The linear adjustment element according to claim 8, wherein said helical line-like wound spiral, which, is formed as a helical spring when the pressure chamber is pressurised, said helical line-like wound spiral expands together with the expansion element along the longitudinal axis to the moved out position and is, thus, pre-tensioned and, when the pressure in the pressure chamber is released, supports a return to the retracted position.

10. The linear adjustment element according to claim 6, wherein the expansion element is connected by interposition of a telescopic tube to the first connection element in a tight manner.

11. The linear adjustment element according to claim 8, wherein the first spiral end is attached on the tube element arranged to the first connection element.

12. The linear adjustment element according to claim 1, wherein the expansion element is made from an elastic rubber material.

13. The linear adjustment element according to claim 1, wherein the connection elements are made from a metal or a plastic material.
